(19) United States
(12) Patent Application Publication
(10) Pub. No.: US 2011/0014347 A1
(43) Pub. Date: Jan. 20, 2011

(54) CEREAL TEA DRINK

(75) Inventors: Noriko Terazawa, Kanagawa (JP); Hideki Maki, Kanagawa (JP); Yoshiaki Yokoo, Kanagawa (JP)

Correspondence Address: DRINKER BIDDLE & REATH (DC), 1500 K STREET, N.W., SUITE 1100, WASHINGTON, DC, 20005-1209, US

(73) Assignee: Suntory Holdings Limited, Osaka (JP)

(21) Appl. No.: 12/680,934

(22) PCT Filed: Sep. 29, 2008
(86) PCT No.: PCT/JP2008/067674

§ 371 Date: Jul. 21, 2010

(30) Foreign Application Priority Data
Oct. 1, 2007 (JP) 2007-257972

(51) Int. Cl. A23F 3/00

(52) U.S. Cl. 426/597

(57) ABSTRACT

The present invention relates to a starch-containing tea beverage. More specifically, the present invention relates to a cereal tea beverage containing starch at a content of 0.009% by weight or more, which has an appropriate roasted aroma and mildness peculiar to cereal tea, relieves the pasty texture originating from the starch, and thereby has an improved taste and flavor, as a result of addition of ultrafine ground tea leaves having an average particle size of 1 μm or less. The present invention also relates to a process for producing such a cereal tea beverage, and a method for improving the taste and flavor of such a cereal tea beverage.

### TECHNICAL FIELD

The present invention relates to starch-containing tea beverages. More specifically, the present invention relates to cereal tea beverages containing starch at a content of 0.009% by weight or more, which have an appropriate roasted aroma and mildness peculiar to cereal tea, relieve the pasty texture originating from the starch, and thereby have an improved taste and flavor.

### BACKGROUND ART

In recent years, the market of sugar-free tea beverages has been growing in response to a rise in health orientation, and there have been developed many cereal tea beverages rich in functional substances, including barley tea, brown rice tea, pearl barley tea, buckwheat tea and so on, in addition to green tea and oolong tea. Cereal tea beverages are generally prepared from cereal grains by being roasted and then extracted with hot water. Cereal tea beverages are liked by consumers because of their roasted aroma and cereal-derived aroma. However, starch originating from cereals may leave a pasty texture (stickiness) as an aftertaste, which impairs the refreshing taste required of tea beverages. In particular, such stickiness becomes remarkable in tea beverages that are drunk in a refrigerated state below room temperature. Thus, there has been a demand for improvements in the taste and flavor of cereal tea beverages.

Some cereal tea beverages, which are modified to relieve this cereal-derived stickiness, are commercially available. In the case of brown rice tea beverages, examples include those modified to have an enhanced roasted aroma by elevating the degree of roast, those modified to have an enhanced refreshing taste originating from green tea by increasing the ratio of green tea to be blended, those blended with cereals other than brown rice, and those supplemented with flavorings to enhance characteristics of aromas and thereby mask stickiness. However, there arises another problem in that such modifications emphasize the roast-induced bitterness or the bitter and astringent taste originating from catechin contained in green tea, or in that such modifications adversely affect the balance of aromas. Thus, these brown rice tea beverages were not fully satisfactory.

On the other hand, there is disclosed a brown rice tea beverage supplemented with a powdered form of mugwort leaves (mugwort powder) (Patent Document 1). However, this document neither suggests nor discloses the starch-derived stickiness originating from cereals (e.g., brown rice), which becomes remarkable particularly upon drinking at a temperature below room temperature.

Patent Document 1: JP 06-113798 A

### DISCLOSURE OF THE INVENTION

### Problems to be Solved by the Invention

The object of the present invention is to provide cereal tea beverages having a refreshing aftertaste, which are designed to suppress the cereal-derived stickiness without impairing the mildness and aroma inherent to cereals.

### Means for Solving the Problems

As a result of extensive and intensive efforts made to achieve the above object, the inventors of the present invention have found that when ultrafine ground tea leaves having an average particle size of 1 μm or less are added to hot water extracts of roasted cereals, it is possible to obtain easily drinkable tea beverages having a refreshing aftertaste and being free from stickiness originating from cereal starch. This finding led to the completion of the present invention.

Namely, the present invention is as follows.

(1) A tea beverage, which comprises starch at a content of 0.009% by weight or more and ultrafine ground tea leaves having an average particle size of 1 μm or less.

(2) The tea beverage according to (1) above, wherein the content of the ultrafine ground tea leaves is 0.02% to 0.5% by weight.

(3) The tea beverage according to (1) or (2) above, wherein the ultrafine ground tea leaves are incorporated in the form of a dispersion.

(4) The tea beverage according to any one of (1) to (3) above, wherein the starch is derived from a cereal.

(5) The tea beverage according to (4) above, wherein the cereal is one or more members selected from brown rice, buckwheat, barley, and pearl barley.

(6) The tea beverage according to any one of (1) to (5) above, which is intended for drinking at a temperature below room temperature.

(7) The tea beverage according to any one of (1) to (6) above, which is a container-filled beverage.

(8) A process for producing a cereal tea beverage, which comprises the following steps:

1. obtaining a solvent extract of a cereal;

2. obtaining a dispersion of ultrafine ground tea leaves; and

3. mixing the solvent extract of a cereal and the dispersion of ultrafine ground tea leaves.

(9) A method for improving the taste and flavor of a cereal tea, which comprises adding ultrafine ground tea leaves having an average particle size of 1 μm or less to suppress stickiness originating from cereal starch.

### Advantages of the Invention

The present invention enables the production of beverages free from bitterness and stickiness originating from cereals while retaining a roasted aroma and a refreshing taste, which are characteristics of cereal tea beverages. These tea beverages are preferred for use as container-filled beverages, because they have a good taste and flavor even in a refrigerated state below room temperature.

Moreover, the tea beverages of the present invention are also advantageous in that they are easy to produce, because they are obtained simply by addition of ground tea leaves to conventionally produced cereal tea.

### BRIEF DESCRIPTION OF THE DRAWINGS

FIG. 1 is a graph showing the results evaluated for stickiness in a sensory test by expert panelists. Stickiness was evaluated by each panelist on a six-point scale: 5 (highly), 4 (considerably), 3 (normally), 2 (somewhat), 1 (slightly) and 0 (not at all), and the scores were averaged over 7 panelists.

FIG. 2 is a graph showing the results evaluated for bitterness/unwanted taste in a sensory test by expert panelists. Bitterness/unwanted taste was evaluated by each panelist on a six-point scale: 5 (highly), 4 (considerably), 3 (normally), 2 (somewhat), 1 (slightly) and 0 (not at all), and the scores were averaged over 7 panelists.

FIG. 3 is a graph showing the results evaluated for refreshing taste in a sensory test by expert panelists. Refreshing taste was evaluated by each panelist on a six-point scale: 5 (highly), 4 (considerably), 3 (normally), 2 (somewhat), 1 (slightly) and 0 (not at all), and the scores were averaged over 7 panelists.

FIG. 4 is a graph showing the results evaluated for overall preference in a sensory test by expert panelists. Overall preference was evaluated by each panelist on a five-point scale: 5 (like), 4 (slightly like), 3 (neither like nor dislike), 2 (slightly dislike) and 1 (dislike), and the scores were averaged over 7 panelists.

FIG. 5 is a graph showing the particle size distributions of a ultrafine ground tea leaf dispersion, a ground tea leaf dispersion (indicated as “Untreated”) and a solution free from both ultrafine ground tea leaves and ground tea leaves (indicated as “Vehicle”).

### BEST MODE FOR CARRYING OUT THE INVENTION

The tea beverages of the present invention are produced by a simple process in which ground tea leaves are added to a solvent extract of a cereal (cereal tea). Details are described below.

(Cereal Tea)

As used herein, the term “cereal tea” is intended to mean a cereal extract that is extracted from cereal grains (starting material) with an aqueous solvent. Any type of cereal may be used as a starting material as long as it can be used in beverages, as exemplified by rice (e.g., roasted rice, brown rice), barley (e.g., Hordeum vulgare, hulless barley), pearl barley, and buckwheat (e.g., buckwheat whole grains of Japanese buckwheat or tartary buckwheat species), which may be used either alone or in combination. Starting cereal grains for cereal tea may be prepared and roasted in a conventional manner.

Such a starting cereal material may be extracted in any manner by using any conventionally known technique. In general, extraction is accomplished as follows. The starting cereal material is used in an amount of about 0.5% to 8% by weight, preferably about 0.5% to 5% by weight, relative to the total weight (sum of the starting cereal material and the solvent). The extraction solvent used for this purpose is not limited in any way as long as it can be used in food products, as exemplified by distilled water, desalted water, tap water, alkaline ionized water, deep sea water, ion exchanged water, deoxygenated water, as well as water-containing alcohol (10 to 90 v/v % alcohol), and mineral-containing water. In particular, pure water and ion exchanged water are preferred for use. This is because an abundance of ions dissolved in water will cause a reduction in extraction efficiency and/or will react with components in the cereal extract to form insoluble products or to cause a change in color.

The amount of the extraction solvent to be used will vary depending on the type of starting cereal material, the type of extraction solvent, the temperature used for extraction, the preferences desired by consumers, etc. In general, it is about 5 to 500 parts by weight, based on the weight of the starting cereal material. The extraction solvent preferably has a temperature high enough to extract the cereal-derived pleasant roasted aroma. More specifically, it has a temperature of about 60° C. to 100° C., preferably about 80° C. to 100° C. The extraction time is 3 to 60 minutes, and preferably 5 to 30 minutes for the purpose of fully eluting cereal-derived aroma components and avoiding excess elution of starch and the like. Moreover, any technique may be used for extraction, including immersion (kneader extraction) or flushing (column extraction). Particularly preferred is column extraction because it allows extraction of the cereal-derived pleasant roasted aroma.

It should be noted that the extraction solvent may be supplemented with an organic acid or an organic acid salt (e.g., sodium ascorbate) before use in extraction.

This extraction step may be followed by known procedures for solid-liquid separation (e.g., filtration or centrifugation) to obtain an extract (cereal tea).

The cereal tea obtained as described above may be mixed with a solvent extract of tea leaves, such as those of fermented tea (e.g., black tea), semi-fermented tea (e.g., oolong tea) or non-fermented tea (e.g., green tea). Alternatively, the starting cereal material may be mixed with these tea leaves and extracted together at the same time.

(Starch)

If tea beverages contain starch, such beverages may leave stickiness as an aftertaste upon drinking in a refrigerated state.

As used herein, the term “stickiness” is intended to mean a sticky or viscous pasty texture.

The present invention is characterized in that ultrafine ground tea leaves are added to tea beverages containing such starch at a content of 0.009% by weight or more, preferably 0.02% by weight or more, to thereby prevent stickiness from being left as an aftertaste.

In this context, starch is of any origin, and may be derived from either the above starting material for cereal tea or an additive incorporated as a nutrient or as a suspension stabilizer. In particular, cereal tea-derived starch is highly regarded as a factor responsible for roundness and softness in the mouth, but on the other hand it has a problem of leaving stickiness as an aftertaste. A preferred target in the present invention is starch that is present as a component within starting cereal materials such as brown rice, buckwheat, barley, pearl barley and so on.

Starch may be quantified, for example, by the enzyme method of the Japan Food Research Laboratories, in which an analyte (tea beverage) is mixed with 50% ethanol, and the insoluble matter is treated with glucoamylase and then measured for its glucose content, which is then multiplied by 0.9.

(Ultrafine Ground Tea Leaves)

The term “ground tea leaves” refers to a finely powdered form of tea leaves, which is obtained by cutting tea leaves into small pieces, separating and removing their veins, and then grinding the remainder in a stone mill or the like. As used herein, the term “ultrafine ground tea leaves” is intended to mean ground tea leaves having an average particle size of 1 μm or less. Although the average particle size of ultrafine ground tea leaves used in the present invention is 1 μm or less, it is preferably 0.01 μm to 1 μm, 0.1 μm to 1 μm, 0.3 μm to 1 μm, or 0.5 μm to 1 μm.

The average particle size of ultrafine ground tea leaves may be measured in any manner by using any known means, e.g., a laser diffraction-type particle size distribution analyzer.

In the present invention, any type of ultrafine ground tea leaves may be used as long as they have an average particle size of 1 μm or less. In general, ultrafine ground tea leaves may be prepared by (i) grinding starting tea leaves (grinding step), (ii) further grinding the resulting tea powder into a more finely powdered form (ultrafine grinding step), and (iii) removing the major portion of particles having a particle size of 1 μm or more (coarse particle removal step).

In step (i) above, tea leaves used as a starting material are not limited in any way, and examples include those of fermented tea, semi-fermented tea, non-fermented tea and so on, more specifically tea leaves belonging to Camellia Sinensis, as exemplified by green tea, oolong tea, black tea, ten-cha (a kind of green tea), roasted green tea, etc. These starting tea leaves may be ground in any manner by using standard grinding techniques, i.e., dry grinding or wet grinding, etc. In this grinding step, starting tea leaves are generally ground into a particle size of about 1 to 100 μm.

In step (ii) above, any means may be used for further grinding into a more finely powdered form, including known means such as a fluid mill, a vibration ball mill, a high pressure homogenizer, etc. In particular, wet grinding in a high pressure homogenizer is preferred in terms of aroma. As used herein, the term “high pressure homogenizer” refers to a device for converting emulsion droplets or suspended particles into an ultra-fine form, for example, by means of shear and/or cavitation generated upon ejecting a liquid from a microspace under high pressure.

In step (iii) above, the major portion of coarse particles having a particle size larger than about 1 μm are removed. As used herein, the term “major portion” is intended to mean about 50% or more, preferably 75% or more, more preferably about 95% or more, and even more preferably 99% or more. Any means may be used for removal of coarse particles in this step as long as it can remove the major portion of coarse particles having a particle size larger than about 1 μm, and centrifugation or the like may be used for this purpose.

In a preferred embodiment, ultrafine ground tea leaves used in the present invention are added in the form of a ultrafine ground tea leaf dispersion. This is because upon addition in such a dispersion form, not only ultrafine ground tea leaves per se, but also components eluted from the leaves can be expected to exert addictively or synergistically the effect of the present invention, i.e., the effect of relieving the starch-derived aftertaste (stickiness). Such a dispersion of ultrafine ground tea leaves can be prepared, for example, as described in WO2004/110161. The ultrafine ground tea leaf dispersion thus obtained has a turbidity of 0.05 to 1.5, as measured by absorbance at 680 nm.

(Tea Beverages)

The tea beverages of the present invention are those having a refreshing aftertaste, which are designed to relieve the starch-derived stickiness by addition of the above ultrafine ground tea leaves to cereal tea containing the above starch at a content of 0.09% by weight or more.

The amount of ultrafine ground tea leaves to be added may be selected as appropriate, in consideration of the type of cereal tea, the content of starch, the degree of the desired effect, the preferences of consumers, etc. In general, it is about 0.02% to 0.5% by weight, preferably about 0.02% to 0.2% by weight, about 0.05% to 0.5% by weight, about 0.05% to 0.2% by weight, about 0.1% to 0.5% by weight, or about 0.1% to 0.2% by weight (calculated as ultrafine ground tea leaves), relative to the total weight of the tea beverage. In an amount less than 0.02% by weight, the suppressive effect on the starch-derived stickiness cannot be obtained sufficiently. On the other hand, when ultrafine ground tea leaves are used in an amount exceeding 0.5% by weight, the use of such an excessive amount is economically disadvantageous because it cannot be expected to provide a further improvement in the suppressive effect on stickiness; and the taste and flavor of ground tea leaves will also affect the aroma of cereal tea.

The tea beverages of the present invention may comprise the above cereal tea and ultrafine ground tea leaves, in admixture with any ingredient available for use in beverages, e.g., additives such as sugars, acidulants, flavorings, etc. In general, the tea beverages of the present invention have a pH of about 5 to 7, preferably about 5.5 to 7 or about 6 to 7.

The tea beverages of the present invention leave little stickiness in the mouth even when drunk in a refrigerated state below room temperature, more specifically below about 20° C., preferably below about 15° C., and more preferably below about 10° C. Thus, container-filled tea beverages, which have been recently provided in a refrigerated state, are one of the preferred embodiments. Any container may be used in such a container-filled tea beverage, and examples include paper cartons, bottles, cans, plastic bottles and the like.

### Examples

The present invention will now be described in more detail by way of the following examples, which are not intended to limit the scope of the invention.

### Example 1

### Brown Rice Tea Beverage (1)

A cylindrical column extractor having a 50-mesh wire gauze was charged with green tea leaves (80 g) and brown rice (120 g), and the upper surface of these starting materials was flattened to a uniform height. Next, ion exchanged water heated to 91° C. (800 mL) was supplied through a shower nozzle located at the top of the column. At 10 seconds after completion of the water supply, ion exchanged water heated to 91° C. was supplied at a rate of 350 mL/min through the shower nozzle located at the top of the column, simultaneously with discharging an extract at the same rate from the bottom of the column At the timing where the volume of water supply from the shower reached 4.2 L, the water supply was stopped and the entire liquid was discharged from the bottom of the column to obtain an extract (cereal tea; green tea-containing brown rice tea). A volume of the extract corresponding to 0.2% tea solid content was taken and filtered, and the resulting filtrate was supplemented with sodium bicarbonate (0.37 g) and L-ascorbic acid (0.4 g), followed by addition of a ultrafine ground tea leaf dispersion, such that the concentration of ultrafine ground tea leaves was 0.1% by weight in the beverage. A total volume of 1000 mL was sterilized and filled.

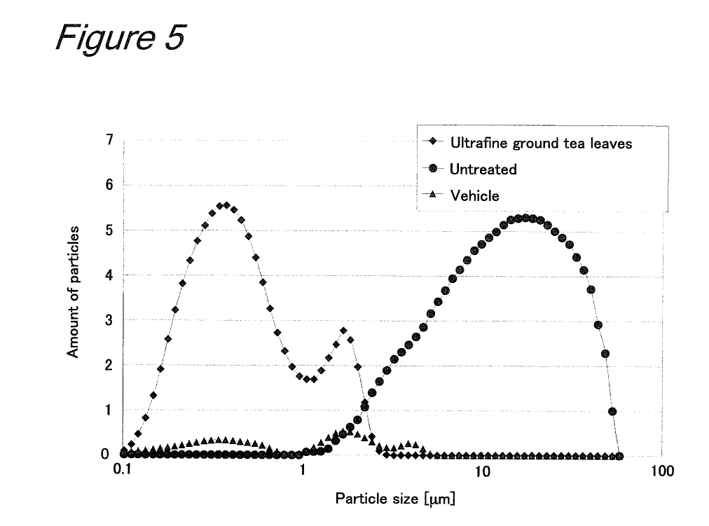

It should be noted that the ground tea leaf dispersion used was prepared as follows: powdered green tea (ground tea leaves) prepared from ten-cha (a kind of green tea) by grinding in a stone mill was suspended in about 80 volumes of water, and this suspension was treated in a high pressure homogenizer under 15 MPa pressure, centrifuged (6000 rpm, 10 minutes) and filtered to give the ultrafine ground tea leaf dispersion. FIG. 5 shows the particle size distribution of the ultrafine ground tea leaf dispersion used in this example.

The resulting tea beverage (ground tea leaf-blended brown rice tea) was measured for its starch content in the following manner.

Starch: The enzyme method was used for measurement. More specifically, a sample was mixed with 50% ethanol to extract and wash off low-molecular-weight sugars, and the remaining insoluble matter was enzymatically digested with glucoamylase. Glucose in the resulting solution was quantified by the mutarotase-glucose oxidase method, and the resulting glucose content was used to calculate the starch content by the following equation.

Starch (g/100 g)=Glucose (g/100 g)×0.9

Furthermore, the aroma of this tea beverage was evaluated by 7 expert panelists. Among the items to be evaluated, bitterness/unwanted taste, refreshing taste, and stickiness were each evaluated on a six-point scale: 5 (highly), 4 (considerably), 3 (normally), 2 (somewhat), 1 (slightly) and 0 (not at all), and an average of the scores was calculated for each item. Likewise, overall preference was evaluated on a five-point scale: 5 (like), 4 (slightly like), 3 (neither like nor dislike), 2 (slightly dislike) and 1 (dislike).

### Example 2

### Brown Rice Tea Beverage (2)

The same procedure as shown in Example 1 was repeated to give an extract (cereal tea; green tea-containing brown rice tea). A volume of the extract corresponding to 0.08% tea solid content was taken and filtered, and the resulting filtrate was mixed with sodium bicarbonate and L-ascorbic acid in the same amounts as used in Example 1 and with the ultrafine ground tea leaf dispersion (0.1% by weight as ultrafine ground tea leaves). A total volume of 1000 mL was sterilized and filled.

The resulting tea beverage was measured for its starch content and evaluated in a sensory test in the same manner as shown in Example 1.

### Example 3

### Brown Rice Tea Beverage (3)

The same procedure as shown in Example 1 was repeated to give an extract (cereal tea; green tea-containing brown rice tea). A volume of the extract corresponding to 0.2% tea solid content was taken and filtered, and the resulting filtrate was supplemented with sodium bicarbonate and L-ascorbic acid in the same amounts as used in Example 1, followed by addition of the ultrafine ground tea leaf dispersion, such that the concentration of ultrafine ground tea leaves was 0.02% by weight in the beverage. A total volume of 1000 mL was sterilized and filled.

The resulting tea beverage was measured for its starch content and evaluated in a sensory test in the same manner as shown in Example 1.

### Comparative Example 1

### Brown Rice Tea Beverage (4)

The same procedure as shown in Example 1 was repeated to give a tea beverage, except that the ultrafine ground tea leaf dispersion was not added. The resulting tea beverage was measured for its starch content and evaluated in a sensory test in the same manner as shown in Example 1.

### Comparative Example 2

### Brown Rice Tea Beverage (5)

The same procedure as shown in Example 2 was repeated to give a tea beverage, except that the ultrafine ground tea leaf dispersion was not added. The resulting tea beverage was measured for its starch content and evaluated in a sensory test in the same manner as shown in Example 1.

### Comparative Example 3

### Brown Rice Tea Beverage (6)

The same procedure as shown in Example 1 was repeated to give a tea beverage, except that the ultrafine ground tea leaf dispersion was replaced by a ground tea leaf dispersion. As a ground tea leaf dispersion, 1 g of powdered green tea (ground tea leaves) prepared from ten-cha (a kind of green tea) by grinding in a stone mill was suspended in about 80 volumes of water and used in an amount of 1 g (0.1% by weight). The particle size distribution of this ground tea leaf dispersion is also shown in FIG. 5 (Untreated).

The resulting tea beverage was measured for its starch content and evaluated in a sensory test in the same manner as shown in Example 1.

### Comparative Example 4

### Brown Rice Tea Beverage (7)

The same procedure as shown in Example 1 was repeated to give a tea beverage, except that the ultrafine ground tea leaf dispersion was replaced by a catechin preparation. As a catechin preparation, Sunphenon ST (Taiyo Kagaku Co., Ltd., Japan) was used in an amount of 1 g (0.1% by weight). The resulting tea beverage was measured for its starch content and evaluated in a sensory test in the same manner as shown in Example 1.

### Comparative Example 5

### Brown Rice Tea Beverage (8)

The same procedure as shown in Comparative Example 4 was repeated to give a tea beverage, except that the catechin preparation was added in an amount of 0.06 g (0.006% by weight). The resulting tea beverage was measured for its starch content and evaluated in a sensory test in the same manner as shown in Example 1.

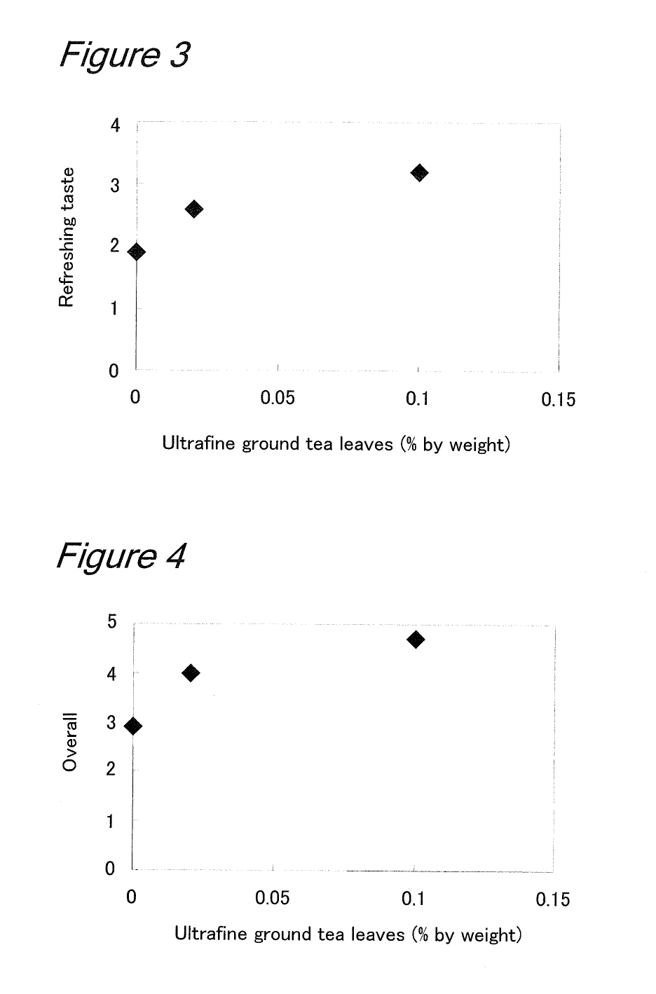

The results evaluated for Examples 1 to 3 and Comparative Examples 1 to 5 are shown in Table 1. In addition, the results obtained for Examples 1 and 3 as well as Comparative Example 1, each having a starch content of 0.02% by weight, are shown in FIGS. 1 to 4.

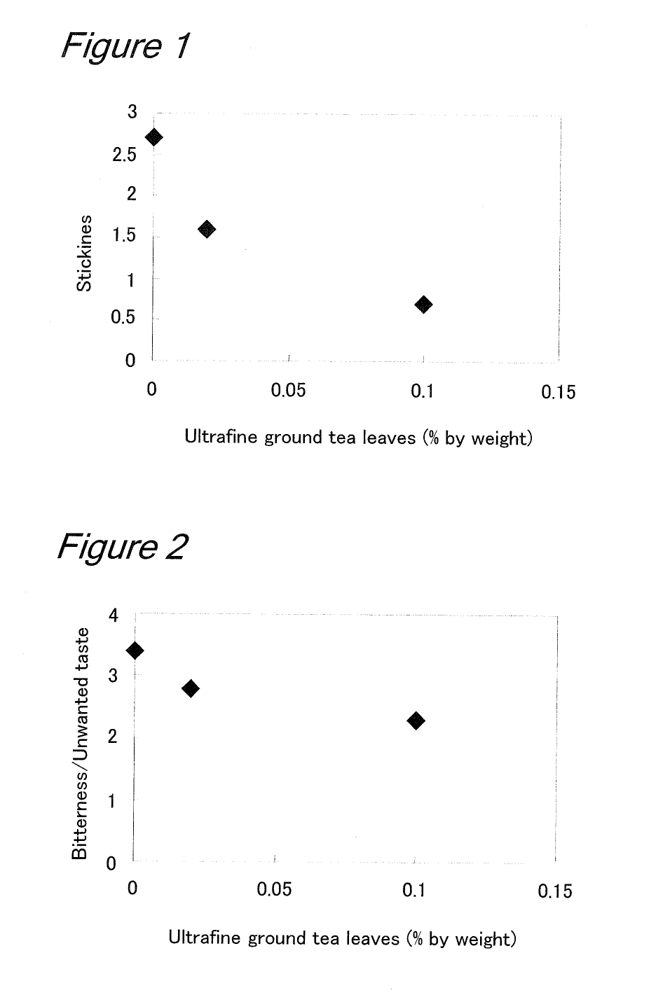

As can be seen from FIG. 1, the stickiness originating from brown rice starch was reduced in a manner dependent on the added amount of ultrafine ground tea leaves. Moreover, in a manner dependent on the added amount of ground tea leaves, the bitterness/unwanted taste was also reduced while the refreshing taste was improved, and hence the overall deliciousness was improved (FIGS. 2 to 4).

Example 2 and Comparative Example 2 demonstrate the effect of ultrafine ground tea leaves added in brown rice tea beverages having a starch content of 0.009% by weight. As in the case of the beverages having a starch content of 0.02% by weight, the stickiness originating from brown rice starch was remarkably relieved, and the bitterness/unwanted taste was also reduced while the refreshing taste was improved, and hence the overall deliciousness was improved.

Example 1 and Comparative Example 3 in comparison with Comparative Example 1 indicated that ultrafine ground tea leaves achieved a remarkable reduction in stickiness, whereas ground tea leaves showed little effect. Moreover, the bitterness/unwanted taste was increased upon addition of ground tea leaves when compared to no addition (Comparative Example 1). Further, addition of ground tea leaves was found to leave graininess in the mouth, thereby reducing the refreshing taste characteristic of tea beverages and also reducing the overall deliciousness. This result indicates that ultrafine ground tea leaves are effective for suppression of the starch-derived stickiness.

On the other hand, as indicated by the results of Comparative Examples 4 and 5, in which the catechin preparation was used instead, there was only a slight reduction in stickiness, and there was not seen the suppressive effect on bitterness/unwanted taste, as observed upon addition of ultrafine ground tea leaves (Example 1), thus leading to no improvement in overall deliciousness. This result suggests that ultrafine ground tea leaves are effective for suppression of the starch-derived stickiness and for improvement of the taste and flavor of cereal tea, but catechin is not effective for these purposes.

TABLE 1

| | | | | Comparative | Comparative | Comparative | Comparative | Comparative |
|---|---|---|---|---|---|---|---|---|
| | Example 1 | Example 2 | Example 3 | Example 1 | Example 2 | Example 3 | Example 4 | Example 5 |
| Ultrafine ground tea leaves | 0.1 | 0.1 | 0.02 | — | — | — | — | — |
| (% by weight) | | | | | | | | |
| Ground tea leaves | — | — | — | — | — | 0.1 | — | — |
| (% by weight) | | | | | | | | |
| Catechin preparation | — | — | — | — | — | — | 0.1 | 0.006 |
| (% by weight) | | | | | | | | |
| Starch content | 0.022 | 0.009 | 0.022 | 0.022 | 0.009 | 0.022 | 0.022 | 0.022 |
| (% by weight) | | | | | | | | |
| Aroma evaluation | | | | | | | | |
| Bitterness/unwanted | 2.3 | 1.1 | 2.8 | 3.4 | 2.8 | 4.9 | 3.3 | 3.3 |
| taste | | | | | | | | |
| Refreshing taste | 3.2 | 3.9 | 2.6 | 1.9 | 1 | 1.3 | 2.4 | 2.4 |
| Stickiness | 0.7 | 0.7 | 1.6 | 2.7 | 2 | 2 | 2.4 | 2.4 |
| Overall | 4.7 | 4 | 4 | 2.9 | 2 | 1 | 2.7 | 2.7 |
| Catechin concentration | 454 | 237 | 417 | 386 | 144 | 448 | 1142 | 437 |
| (ppm) | | | | | | | | |

### Example 4

### Buckwheat Tea Beverage

Using the same column as used in Example 1, extraction was performed under the same conditions, except that the brown rice and green tea leaves were replaced by a starting material for buckwheat tea (200 g). A volume of the extract corresponding to 0.26% tea solid content was filtered and mixed with sodium bicarbonate and L-ascorbic acid in the same amounts as used in Example 1 and with ultrafine ground tea leaves (1 g). A total volume of 1000 mL was sterilized and filled.

The resulting tea beverage was measured for its starch content and evaluated in a sensory test in the same manner as shown in Example 1.

### Example 5

### Barley Tea Beverage

Using the same column as used in Example 1, extraction was performed under the same conditions, except that the brown rice and green tea leaves were replaced by a starting material for barley tea (barley, 200 g). A volume of the extract corresponding to 0.32% tea solid content was filtered and supplemented with sodium bicarbonate and L-ascorbic acid in the same amounts as used in Example 1, followed by addition of ultrafine ground tea leaves (2 g). A total volume of 1000 mL was sterilized and filled.

The resulting tea beverage was measured for its starch content and evaluated in a sensory test in the same manner as shown in Example 1.

### Example 6

### Cereal Tea Beverage (Blend Tea Beverage)

Using the same column as used in Example 1, extraction was performed under the same conditions, except that the brown rice and green tea leaves were replaced by brown rice (25 g), barley (25 g) and pearl barley (150 g) (total weight of starting cereal materials: 200 g). After addition of sodium bicarbonate and L-ascorbic acid in the same amounts as used in Example 1, ultrafine ground tea leaves (2 g) were mixed. A total volume of 1000 mL was sterilized and filled.

The resulting tea beverage was measured for its starch content and evaluated in a sensory test in the same manner as shown in Example 1.

The results obtained for Examples 4 to 6 are shown in Table 2. The buckwheat tea, barley tea and cereal tea (blend tea), each containing the ultrafine ground tea leaf dispersion at a content of 0.1% to 0.2% by weight, were found to have a refreshing taste with less stickiness originating from cereal starch and less bitterness/unwanted taste. Their overall deliciousness was also evaluated as good.

TABLE 2

| | Example 4 | Example 5 | Example 6 |
|---|---|---|---|
| | Buckwheat tea | Barley tea | Blend tea |
| Ultrafine ground tea leaves | 0.1 | 0.2 | 0.2 |
| (% by weight) | | | |
| Starch content | 0.1 | 0.3 | 0.2 |
| (% by weight) | | | |
| Aroma evaluation | | | |
| Bitterness/unwanted taste | 1.6 | 1.5 | 1.2 |
| Refreshing taste | 1.8 | 3 | 2.8 |
| Stickiness | 2.1 | 2.1 | 2.2 |
| Overall | 3.3 | 3.4 | 3.2 |
| Catechin concentration (ppm) | 124 | 143 | 130 |

1. A tea beverage, which comprises starch at a content of 0.009% by weight or more and ultrafine ground tea leaves having an average particle size of 1 μm or less.

2. The tea beverage according to claim 1, wherein the content of the ultrafine ground tea leaves is 0.02% to 0.5% by weight.

3. The tea beverage according to claim 1, wherein the ultrafine ground tea leaves are incorporated in the form of a dispersion.

4. The tea beverage according to claim 1, wherein the starch is derived from a cereal.

5. The tea beverage according to claim 4, wherein the cereal is one or more members selected from brown rice, buckwheat, barley, and pearl barley.

6. The tea beverage according to claim 1, which is intended for drinking at a temperature below room temperature.

7. The tea beverage according to claim 1, which is a container-filled beverage.

8. A process for producing a cereal tea beverage, which comprises the following steps:
1. obtaining a solvent extract of a cereal;
2. obtaining a dispersion of ultrafine ground tea leaves; and
3. mixing the solvent extract of a cereal and the dispersion of ultrafine ground tea leaves.

9. A method for improving the taste and flavor of a cereal tea, which comprises adding ultrafine ground tea leaves having an average particle size of 1 μm or less to suppress stickiness originating from cereal starch.

10. The tea beverage according to claim 2, wherein the ultrafine ground tea leaves are incorporated in the form of a dispersion.

11. The tea beverage according to claim 2, wherein the starch is derived from a cereal.

12. The tea beverage according to claim 3, wherein the starch is derived from a cereal.

13. The tea beverage according to claim 2, which is intended for drinking at a temperature below room temperature.

14. The tea beverage according to claim 3, which is intended for drinking at a temperature below room temperature.

15. The tea beverage according to claim 4, which is intended for drinking at a temperature below room temperature.

16. The tea beverage according to claim 5, which is intended for drinking at a temperature below room temperature.

17. The tea beverage according to claim 2, which is a container-filled beverage.

18. The tea beverage according to claim 3, which is a container-filled beverage.

19. The tea beverage according to claim 4, which is a container-filled beverage.

20. The tea beverage according to claim 5, which is a container-filled beverage.

21. The tea beverage according to claim 6, which is a container-filled beverage.
